(19) United States
(12) Patent Application Publication
(10) Pub. No.: US 2015/0097642 A1
(43) Pub. Date: Apr. 9, 2015

(54) COMBINED TYPE RFeB-BASED MAGNET AND METHOD FOR PRODUCING COMBINED TYPE RFeB-BASED MAGNET

(71) Applicant: Shinobu TAKAGI, Aichi (JP)

(72) Inventor: Shinobu TAKAGI, Aichi (JP)

(73) Assignee: DAIDO STEEL CO., LTD., Aichi (JP)

(21) Appl. No.: 14/501,966

(22) Filed: Sep. 30, 2014

(30) Foreign Application Priority Data
Oct. 4, 2013 (JP) 2013-208937

(51) Int. Cl. H01F 1/057; H01F 41/00; H01F 7/02; B23K 20/02

(52) U.S. Cl. CPC H01F 1/057; B23K 20/02; H01F 41/00; H01F 7/021; B23K 2201/00
USPC 335/306; 228/194

(57) ABSTRACT

Provided is a combined type RFeB-based magnet, including: two or more unit magnets; and an interface material that bonds bonding surfaces of the unit magnets adjacent to each other, in which each of the unit magnets is an RFeB-based magnet containing a light rare earth element R^{L} that is at least one element selected from the group consisting of Nd and Pr, Fe, and B, in which the interface material contains at least one compound selected from the group consisting of a carbide, a hydroxide, and an oxide of the light rare earth element R^{L}, and in which the combined type RFeB-based magnet contains at least one element selected from the group consisting of Dy, Ho and Tb, and has a nonplanar surface.

### FIELD OF THE INVENTION

The present invention relates to an RFeB-based magnet that contains R (rare earth element), Fe, and B, and particularly, to a combined type RFeB-based magnet which includes two or more unit magnets and an interface material that bonds bonding surfaces of adjacent unit magnets to each other, and a method for producing a combined type RFeB-based magnet.

### BACKGROUND OF THE INVENTION

The RFeB-based magnet was found by Sagawa et. al. in 1982, and has an advantage that many magnetic properties such as residual magnetic flux density are higher than that of permanent magnets in the related art. Accordingly, the RFeB-based magnet has been used in various products such as a drive motor of a hybrid car and an electric car, a motor for electrically-assisted bicycles, an industrial motor, a voice coil motor of a hard disk drive and the like, a high-performance speaker, a headphone, and a permanent magnet-type magnetic resonance diagnostic device.

Early RFeB-based magnets have a defect that among various magnetic properties, a coersive force H_{CJ} is relatively low. However, it has been apparent that the coercive force is improved by making at least one element selected from the group consisting of Dy, Tb and Ho be present inside the RFeB-based magnet (hereinafter, at least one element selected from the group consisting of Dy, Tb, and Ho is referred to as a “heavy rare earth element R^{H}”). The coersive force is a force that resists inversion of magnetization when a magnetic field in a direction opposite to a direction of the magnetization is applied to a magnet, but it is considered that the heavy rare earth element R^{H} hinders the inversion of magnetization and thus has an effect of increasing the coersive force.

When examining a magnetization inversion phenomenon in the magnet in detail, there is a characteristic that the magnetization inversion occurs at first in the vicinity of a grain boundary of crystal grains and is diffused to the inside of the crystal grains therefrom. Therefore, in a case where the magnetization inversion at the grain boundary is blocked at first, it is effective for prevention of the magnetization inversion of the entirety of the magnet, that is, an increase in the coersive force. Accordingly, the heavy rare earth element R^{H} should be present in the vicinity of the grain boundary of the crystal grains.

On the other hand, when considering the entirety of main phase grains, if an amount of the R^{H} increases, a residual magnetic flux density Bᵣ decreases, and thus there is a problem that the maximum energy product (BH)ₘₐₓ also decreases. In addition, the R^{H} is a rare resource and is expensive, and a production area is localized, and thus it is not preferable to increase the amount of R^{H}. Accordingly, it is preferable that the R^{H} is present in a small amount at the inside of the crystal grains, and be present in a large amount (unevenly distributed) in the vicinity of a surface (in the vicinity of the grain boundary) to increase the coersive force (to prevent a reverse magnetic domain from being formed as much as possible) while suppressing the amount of R^{H} as much as possible.

As a method of unevenly distributing the R^{H} in the vicinity of the surface rather than the inside of the crystal grains, a grain boundary diffusion method is known. In the grain boundary diffusion method, a powder, which contains the R^{H} as an elementary substance, a compound, or an alloy, and the like are attached to a surface of the RFeB-based magnet, and the RFeB-based magnet is heated. According to this, the R^{H} penetrates to the inside of the magnet through the grain boundary of the RFeB-based magnet, and thus atoms of the R^{H} are diffused only to in the vicinity of the surface of the crystal grains.

There are various methods of attaching the attachment material to the base material. Patent Document 1 discloses that the base material is immersed in a turbid solution in which a TbF₃ powder that is an R^{H}-containing powder and ethanol are mixed, and then the base material is pulled up from the turbid solution and is dried, thereby attaching the R^{H}-containing powder to the surface of the base material. However, in this method, it is difficult to uniformly attach the R^{H}-containing powder to the surface of the base material in an arbitrary thickness, and thus a layer of a residual material of the R^{H}-containing powder is apt to be formed with unevenness on the surface of the RFeB-based magnet after the grain boundary diffusion treatment. In a case where the RFeB-based magnet is used in a motor, a spacing between a rotator and a stator of the motor is set to be small, but when the unevenness is present on the RFeB-based magnet that is used as the rotator or the stator, rotation of the motor is physically blocked, or a magnetic field becomes uneven, and thus smooth rotation is hindered.

On the other hand, Patent Document 2 discloses a configuration in which a plurality of rectangular parallelepiped RFeB-based magnets (hereinafter, an individual RFeB-based magnet is referred to as a “unit magnet”) are stacked, and heating is performed with R^{H} metal foil interposed between adjacent unit magnets to perform the grain boundary diffusion treatment. In the method, the R^{H} metal foil serves as a supply source of grain boundary diffusion elements, and as an adhesive, and thus a combined type RFeB-based magnet, in which the adjacent unit magnets are bonded to each other, is obtained.

Patent Document 2 discloses that when the combined type RFeB-based magnet that is obtained in this manner is used in a motor, an eddy current that goes across an interface between the unit magnets is less likely to occur, and thus Joule heat can be suppressed. However, a layer composed of R^{H} that is a metal is present at the interface between the unit magnets, and thus it is difficult to sufficiently block the eddy current that goes across the interface.

Patent Document 3 discloses that the grain boundary diffusion treatment is individually performed with respect to the plurality of unit magnets, and then the plurality of unit magnets are bonded to each other with an organic adhesive to obtain one fan-shaped combined type RFeB-based magnet. During the grain boundary diffusion treatment, a mixed solution of a TbF₃ powder and ethanol is applied to the surface of the unit magnets except for a fan-shaped curved surface (nonplanar surface). In the combined type RFeB-based magnet of Patent Document 3, an adhesive is used for bonding of the unit magnets, and thus it is effective in consideration of blocking of the eddy current, but there is a disadvantage that heat resistance is low.

In addition, the RFeB-based magnet is largely classified into (i) a sintered magnet obtained by sintering a raw material alloy powder containing a main phase grain as a main component, (ii) a bonded magnet obtained by tightening raw material alloy powders with a binding agent (binder composed of an organic material such as a polymer and an elastomer) and by molding the tightened powders, and (iii) a hot-plastic worked magnet obtained by performing a hot press working and hot plastic working with respect to a raw material alloy powder (refer to Non-Patent Document 1). Among these magnets, the grain boundary diffusion treatment may be performed in (i) sintered magnet and (iii) hot-plastic worked magnet in which the binder of the organic material is not used and thus heating during the grain boundary diffusion treatment can be performed.

[Patent Document 1] JP-A-2006-303433

[Patent Document 2] JP-A-2007-258455

[Patent Document 3] JP-A-2009-254092

[Patent Document 4] JP-A-2006-019521

[Non-Patent Document 1] “Development of Dy-omitted Nd—Fe—B-based hot worked magnet by using a rapidly quenched powder as a raw material” written by HIOKI Keiko and HATTORI Atsushi, Sokeizai, Vol. 52, No. 8, pages 19 to 24, General Incorporation Foundation of Sokeizai Center, published on August, 2011

### SUMMARY OF THE INVENTION

An object of the invention is to provide a combined type RFeB-based magnet which is an RFeB-based magnet having a nonplanar surface and which is capable of suppressing occurrence of an eddy current as much as possible during use, and a method for producing a combined type RFeB-based magnet.

In order to solve the above-mentioned problems, the present invention provides a combined type RFeB-based magnet, including: two or more unit magnets; and an interface material that bonds bonding surfaces of the unit magnets adjacent to each other, in which each of the unit magnets is an RFeB-based magnet containing a light rare earth element R^{L} that is at least one element selected from the group consisting of Nd and Pr, Fe, and B, in which the interface material contains at least one compound selected from the group consisting of a carbide, a hydroxide, and an oxide of the light rare earth element R^{L}, and in which the combined type RFeB-based magnet contains at least one element selected from the group consisting of Dy, Ho and Tb, and has a nonplanar surface.

In addition, a carbide, a hydroxide, and an oxide of a heavy rare earth element R^{H} may be contained in the interface material in addition to the carbide, the hydroxide, and the oxide of a light rare earth element R^{L}. In addition, it is preferable that the heavy rare earth element R^{H} contained in the combined type RFeB-based magnet is introduced by a grain boundary diffusion method.

According to the combined type RFeB-based magnet according to the invention, two adjacent unit magnets are bonded to each other by an interface material that contains at least one compound selected from the group consisting of the carbide, the hydroxide, and the oxide of the light rare earth element R^{L}. Accordingly, the interface material electrically insulates the unit magnets. As a result, it is possible to suppress an eddy current from occurring during use of the combined type RFeB-based magnet according to the invention. The interface material has an electrical resistivity higher than that of the heavy rare earth element R^{H} foil described in Patent Document 2, and thus it is possible to further increase an effect of suppressing the eddy current, and the combined type RFeB-based magnet according to the invention has an advantage that heat resistance is higher than the adhesive described in Patent Document 3.

The combined type RFeB-based magnet according to the invention can be produced by the following method. That is to say, a method for producing a combined type RFeB-based magnet in which a plurality of unit magnets that are sintered magnets or hot-plastic worked magnets are bonded to each other at a bonding surface and which has a nonplanar surface, sintered magnets or the hot-plastic worked magnets being an RFeB-based magnet that contains at least one kind of light rare earth element R^{L} selected from Nd and Pr, Fe, and B, the method including: performing heating in a state in which bonding surfaces of two unit magnets adjacent to each other in the combined type RFeB-based magnet are brought into contact with each other through paste obtained by mixing a metal powder containing at least one kind of heavy rare earth element R^{H} selected from Dy, Ho, and Tb, and an organic material to perform a grain boundary diffusion treatment.

According to the method for producing a combined type RFeB-based magnet according to the invention, atoms of the heavy rare earth element R^{H} that is contained in a paste diffuses to a grain boundary phase inside the unit magnet by the above-described grain boundary diffusion treatment, and atoms of the light rare earth element R^{L} of a grain boundary phase inside the unit magnet are substituted with atoms of the heavy rare earth element R^{H}. According to this, the substituted atoms of the light rare earth element R^{L} reach the bonding surface of the unit magnet and react with the organic material that is contained in the paste to generate a carbide, a hydroxide, and/or an oxide, whereby an interface material is generated. In addition, in combination with the reaction, the heavy rare earth element R^{H} that resides inside the paste may react with the organic material to generate a carbide, a hydroxide, and/or an oxide of the heavy rare earth element R^{H}.

In addition, the combined type RFeB-based magnet according to the invention can be manufactured by the above-described method, and thus it is possible to make the heavy rare earth element R^{H} diffuse from the bonding surface to the inside of the unit magnet. According to this, it is not necessary for paste (or an R^{H}-containing powder of the related art, and the like) to be brought into contact with a nonplanar surface of the combined type RFeB-based magnet according to the invention during manufacturing, and it is not necessary to remove a residual material of the paste and the like from the nonplanar surface. Accordingly, it is possible to form a nonplanar surface without unevenness.

In the combined type RFeB-based magnet according to the invention and the method for producing the combined type RFeB-based magnet, it is preferable that the bonding surface is a planar surface in consideration of easy shape matching at the bonding surfaces of adjacent unit magnets, and easy attachment of the paste.

In addition, in the combined type RFeB-based magnet according to the invention and the method for producing a combined type RFeB-based magnet, it is preferable that the bonding surface do not intersect with the nonplanar surface. According to this, the interface material is not exposed to the nonplanar surface, and thus it is possible to prevent unevenness due to the interface material from being forming in the nonplanar surface.

In the combined type RFeB-based magnet according to the invention and the method for producing the combined type RFeB-based magnet, as one shape of the combined type RFeB-based magnet, a tubular shape having a ring-shaped cross-section may be exemplified. In this case, the unit magnet may be configured to have a bonding surface that extends in a central axial direction of the tubular magnet.

As another shape of the combined type RFeB-based magnet, a rectangular parallelepiped shape (dome shape) in which only one surface is an arc surface (surface having a radius of curvature in only one direction) may be exemplified. In this case, the unit magnet may be configured to have a bonding surface that does not intersect with the dome-shaped arc surface and an opposite surface of the arc surface, and the bonding surface may be a surface parallel with the opposite surface. In this divisional aspect, among a plurality of the unit magnets, only a unit magnet at a roof portion of the dome shape has the arc surface. In addition, in the dome-shaped combined type RFeB-based magnet, a unit magnet that is divided in another aspect may be used. For example, when the bonding surface is a surface that intersects with the arc surface, a plurality of unit magnets have the arc surface.

As another shape of the combined type RFeB-based magnet, a fan surface body shape, which has a first arc surface and a second arc surface that is opposite to the first arc surface, may be exemplified. In this case, the bonding surface of the unit magnet may be configured as an arc surface that is positioned between the first arc surface and the second arc surface.

According to the invention, a combined type RFeB-based magnet, which is an RFeB-based magnet having a nonplanar surface and which is capable of suppressing occurrence of an eddy current as much as possible during use, is obtained.

### BRIEF DESCRIPTION OF THE DRAWINGS

FIGS. 1A to 1C illustrate a cross-sectional view of a unit magnet in a tubular ring-shaped combined type RFeB-based magnet having a ring-shaped cross-section which is Example of the combined type RFeB-based magnet according to the invention, and a cross-sectional view and a perspective view of the ring-shaped combined type RFeB-based magnet, respectively.

FIGS. 2A to 2F are schematic views illustrating Example of a method for producing the combined type RFeB-based magnet according to the invention.

FIGS. 3A to 3C illustrate a cross-sectional view of the unit magnet in another Example of the ring-shaped combined type RFeB-based magnet, and a cross-sectional view and a perspective view of the ring-shaped combined type RFeB-based magnet, respectively.

FIG. 4 is a perspective view of another Example of the ring-shaped combined type RFeB-based magnet.

FIGS. 5A to 5C illustrate a cross-sectional view of a unit magnet in Example of a dome-shaped combined type RFeB-based magnet, and a cross-sectional view and a perspective view of the dome-shaped combined type RFeB-based magnet, respectively.

FIGS. 6A to 6C illustrate a cross-sectional view of the unit magnet in another Example of the dome-shaped combined type magnet, and a cross-sectional view and a perspective view of the dome-shaped combined type RFeB-based magnet, respectively.

FIG. 7 is a perspective view of another Example of the dome-shaped combined type magnet.

FIGS. 8A to 8C illustrate a cross-sectional view of a unit magnet in Example of a combined type RFeB-based magnet that is a fan surface body, and a front view and a perspective view of the fan surface body-shaped combined type RFeB-based magnet, respectively.

FIGS. 9A to 9C are views illustrating a specimen that is cut during measurement of magnetic properties and EPMA of the dome-shaped combined type magnet that is prepared in Examples.

FIG. 10 is a view illustrating surface analysis results of EPMA which is performed with respect to the dome-shaped combined type RFeB-based magnet that is prepared in Examples.

FIG. 11 is a view illustrating linear analysis results of EPMA which is performed with respect to the dome-shaped combined type RFeB-based magnet that is prepared in Examples.

### DETAILED DESCRIPTION OF THE INVENTION

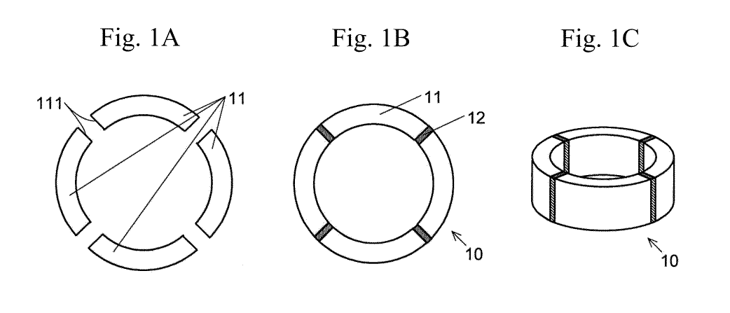

Examples of a combined type RFeB-based magnet according to the invention and a method for producing the combined type RFeB-based magnet will be described with reference to FIG. 1A to FIG. 11.

### EXAMPLES

### (1) Example of Combined Type RFeB-Based Magnet According to Invention

FIGS. 1A to 1C illustrate a ring-shaped combined type RFeB-based magnet 10 that is Example of the combined type RFeB-based magnet according to the invention, a unit magnet 11 in the ring-shaped combined type RFeB-based magnet 10. In Example, a sintered magnet, which mainly contains Nd as a light rare earth element R^{L}, is used as the unit magnet 11. The ring-shaped combined type RFeB-based magnet 10 is a tubular magnet having a ring-shaped cross-section (FIG. 1B). The unit magnet 11 has a partial shape obtained by dividing the ring-shaped tubular magnet into four pieces at a surface 111, which extends in a central axial direction of the ring-shaped tubular magnet, for a unit of 90° in a peripheral direction. The surface 111 is a planar surface, and the surface 111 becomes the above-described bonding surface. In Example, the bonding surface 111 is set to include the central axis, but the bonding surface 111 may not include the central axis as long as the bonding surface 111 extends in the central axial direction. The ring-shaped combined type RFeB-based magnet 10 has a configuration in which unit magnets 11 adjacent to each other in a peripheral direction of a ring are bonded to each other by an interface material 12 at the bonding surface 111. The interface material 12 contains an oxide of Nd that is the light rare earth element R^{L}. In addition, in Example, as a composition before performing the following grain boundary diffusion treatment, the unit magnet 11 having a composition including Nd: 23.3% by mass, Pr: 5.0% by mass, Dy: 3.8% by mass, B: 0.99% by mass, Co: 0.9% by mass, Cu: 0.1% by mass, Al: 0.1% by mass, and Fe: the remainder was used. In addition, atoms of Tb that is a heavy rare earth element R^{H} diffuse to the unit magnet 11 by the following grain boundary diffusion treatment.

### (2) Example of Method for Producing Combined Type RFeB-Based Magnet According to Invention

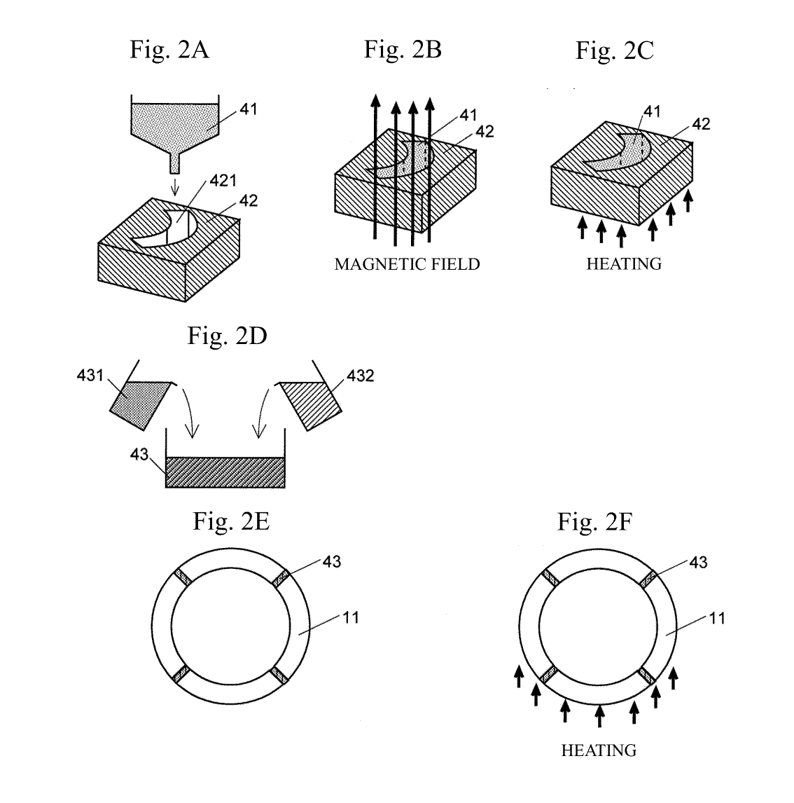

Next, a method for producing the ring-shaped combined type RFeB-based magnet 10 will be described with reference FIGS. 2A to 2F.

First, the unit magnet 11 was prepared by using a method described in Patent Document 4 according to the following method. In the method described in Patent Document 4, a sintered magnet is prepared without compression molding an alloy powder of a raw material, and thus the method is called a PLP (Press-less Process) method. Since compression molding is not performed, the PLP method has an advantage that a coercive force can be improved while suppressing a decrease in a residual magnet flux density, and a sintered magnet with a complicated shape having a nonplanar shape can be easily manufactured. Specifically, a strip cast alloy having the same composition as the unit magnet 11 to be prepared is hydrogen-crushed, and is finely pulverized with a jet mill, thereby preparing an alloy powder 41 having an average particle size, which is a value measured by a laser method, of 0.1 μm to 10 μm, and preferably 3 μm to 5 μm. Next, the alloy powder was filled in a cavity 421 of a mold 42 which has the same shape as that of the unit magnet 11 and a size larger than that of the unit magnet 11 (FIG. 2A), and the alloy powder 41 in the cavity 421 was oriented in a magnetic field without compression (FIG. 2B). Then, heating was performed (a heating temperature of typically 950° C. to 1050° C.) in a state in which the alloy powder 41 was filled in the cavity 421 without compression, thereby sintering the alloy powder 41 (FIG. 2C). According to this, the unit magnet 11 was obtained.

Independently from the preparation of the unit magnet 11, an R^{H}-containing paste 43 for bonding of unit magnets 11 was prepared by mixing an R^{H}-containing metal powder 431 containing the heavy rare earth element R^{H} and silicone grease 432 as an organic material (FIG. 2D).

As the R^{H}-containing metal powder 431, a powder of a TbNiAl alloy having a content rate of Tb: 92% by mass, Ni: 4.3% by mass, and Al: 3.7% by mass was used. It is preferable that a particle size of the R^{H}-containing metal powder 431 is as small as possible for uniform diffusion into the unit magnet 11, but when the particle size is too small, effort and cost for miniaturization increase. Therefore, it is preferable that the particle size is set to 2 μm to 100 μm. The silicone grease 432 has a function of oxidizing atoms of R^{H} in the paste during the grain boundary diffusion treatment when considering that the silicone is a polymeric compound having a main skeleton formed by a siloxane bond of a silicon atom and an oxygen atom. A mixing ratio by weight of the R^{H}-containing metal powder 431 and the silicone grease 432 may be arbitrarily selected for adjustment of a desired paste viscosity. However, when the mixing ratio of the R^{H}-containing metal powder 431 is low, an amount of penetration of the R^{H} atoms into the unit magnet 11 also decreases during the grain boundary diffusion treatment. Therefore, it is preferable that the ratio of the R^{H}-containing metal powder 431 be set to 70% by mass or more, more preferably 80% by mass or more, and still more preferably 90% by mass or more. In addition, when the amount of the silicone grease 432 is less than 5% by mass, sufficient pasting does not occur, and thus the amount of the silicone grease 432 is preferably 5% by mass or more. Furthermore, in addition to the silicone grease 432, a silicone-based organic solvent may be added to adjust the viscosity of the R^{H}-containing paste 43.

Four unit magnets 11 that are obtained in this manner are arranged in a peripheral direction of a ring after applying the R^{H}-containing paste 43 to each of the bonding surfaces 111, and the bonding surfaces 111 of adjacent unit magnets 11 are brought into contact with each other through the R^{H}-containing paste 43 (FIG. 2E). In this state, the four unit magnets 11 and the R^{H}-containing paste 43 are heated at 900° C. in a vacuum atmosphere (FIG. 2F). According to this, Tb atoms in the R^{H}-containing paste 43 diffuse to the inside of the unit magnets 11 through a grain boundary. In addition, as can be seen from the results of the following composition analysis, Nd atoms that are substituted with Tb atoms in the unit magnets 11 precipitate between the unit magnets 11, and react with oxygen atoms in silicones contained in the R^{H}-containing paste 43 and are oxidized. According to the oxidizing operation, the interface material 12 that contains an Nd oxide is formed between the unit magnets 11. In this manner, it is possible to obtain the ring-shaped combined type RFeB-based magnet 10 in which the adjacent unit magnets 11 are strongly bonded to each other by the interface material 12.

In the ring-shaped combined type RFeB-based magnet 10 according to this Example, Tb atoms in the R^{H}-containing paste 43 diffuse to the inside of each of the unit magnets 11, and thus the coercive force is improved. In combination with the improvement of the coercive force, electrical resistivity increases due to the Nd oxide that is formed in the interface material 12, and thus even when being used in an environment such as a motor in which an external magnetic field varies, it is possible to suppress an eddy current from being generated. In addition, it is not necessary to attach the R^{H}-containing paste 43 to an external surface of the ring-shaped combined type RFeB-based magnet 10, and thus it is not necessary to remove a residue of the R^{H}-containing paste 43 from the external surface that is a nonplanar surface. Accordingly, it is possible to reduce the number of processes, and it is possible to prevent shape accuracy of the nonplanar surface from decreasing due to the residue of the R^{H}-containing paste 43.

### (3) Another Example of Combined Type RFeB-Based Magnet According to Invention

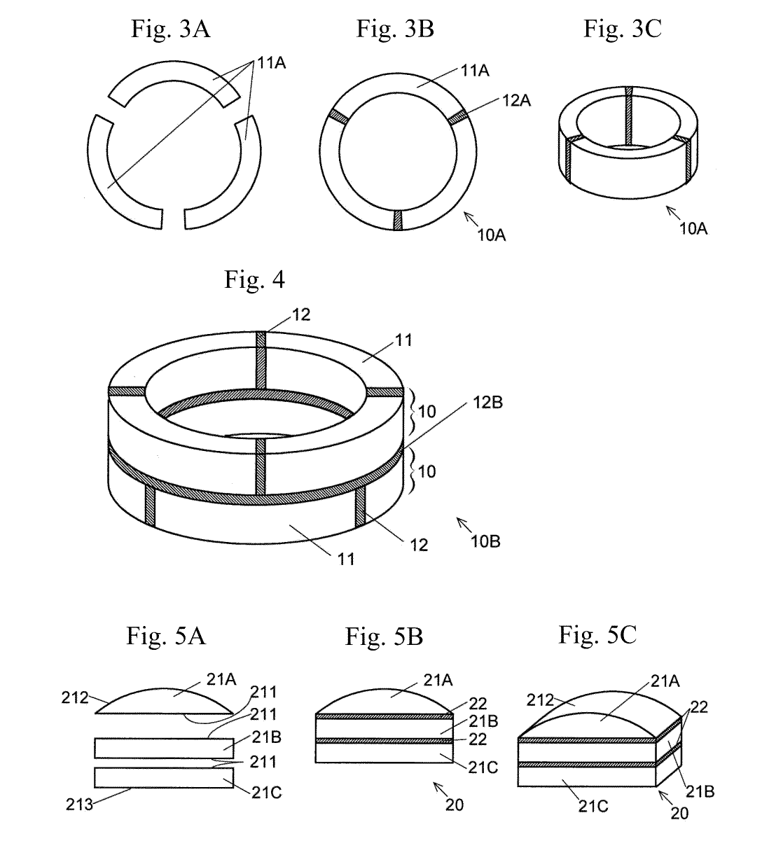

Another Example of the combined type RFeB-based magnet according to the invention will be described with reference to FIGS. 3A to 8C.

Another Example of the ring-shaped combined type RFeB-based magnet is illustrated in FIGS. 3A to 3C and FIG. 4. In a ring-shaped combined type RFeB-based magnet 10A illustrated in FIGS. 3A to 3C, three unit magnets 11A, which have a shape obtained by dividing one ring into three pieces for a unit of 120° in a peripheral direction, are used. Each of the unit magnets 11A has the same configuration as the unit magnet 11 in the above-described Example except for the shape. In addition, an interface material 12A is the same as the interface material 12 in the above-described Example. The ring-shaped combined type RFeB-based magnet 10B shown in FIG. 4 is obtained by stacking two ring-shaped combined type RFeB-based magnets 10 described above in a central axial direction and by bonding these with the interface material 12B. The two ring-shaped combined type RFeB-based magnets 10 are disposed in such a manner that interface materials 12 deviate from each other by 45° in the peripheral direction. A planar shape of the interface material 12B is the same ring shape as the ring-shaped combined type RFeB-based magnet 10. The composition of the interface material 12B is the same as that of the interface material 12.

FIGS. 5A to 5C illustrate Example of a dome-shaped combined type magnet. The dome-shaped combined type magnet 20 has a dome shape in which only an upper surface 212 of rectangular parallelepiped is an arc surface. In this Example, the upper surface 212 has an arc shape at a cross-section in one direction, and a linear shape at a cross-section perpendicular to the above-described cross-section. A unit magnet of the dome-shaped combined type magnet 20 includes a first unit magnet 21A, a second unit magnet 21B, and a third unit magnet 21C that are obtained by dividing the dome-shaped combined type magnet 20 into three pieces at a planar surface parallel with a lower surface 213 opposite to the upper surface (arc surface) 212. Each of planar surfaces that are generated by the above-described division becomes the bonding surface 211. The first unit magnet 21A has the arc surface 212, and the second unit magnet 21B and the third unit magnet 21C have a flat plate shape. An interface material 22 is provided between the first unit magnet 21A and the second unit magnet 21B, and between the second unit magnet 21B and the third unit magnet 21C, respectively. A material of the interface material 22 is the same as the material of the interface material 12 in the ring-shaped combined type RFeB-based magnet 10.

The dome-shaped combined type magnet 20 is prepared by the same method as the ring-shaped combined type RFeB-based magnet 10. That is, the respective unit magnets 21A to 21C are prepared by using molds having a cavity corresponding to the shape of each of the unit magnets 21A to 21C in accordance with the PLP method, and the R^{H}-containing paste is prepared. Then, the R^{H}-containing paste is applied to the bonding surface 211, and then heating is performed at 900° C. in a state in which the three unit magnets 21A to 21C are superimposed on each other, thereby preparing the dome-shaped combined type magnet 20.

In addition, FIGS. 5A to 5C illustrate an example in which two flat plate-shaped unit magnets (the second unit magnet 21B and the third unit magnets 21C) are used, but only one plate-shaped unit magnet may be used, or three or more plate-shaped unit magnets may be stacked.

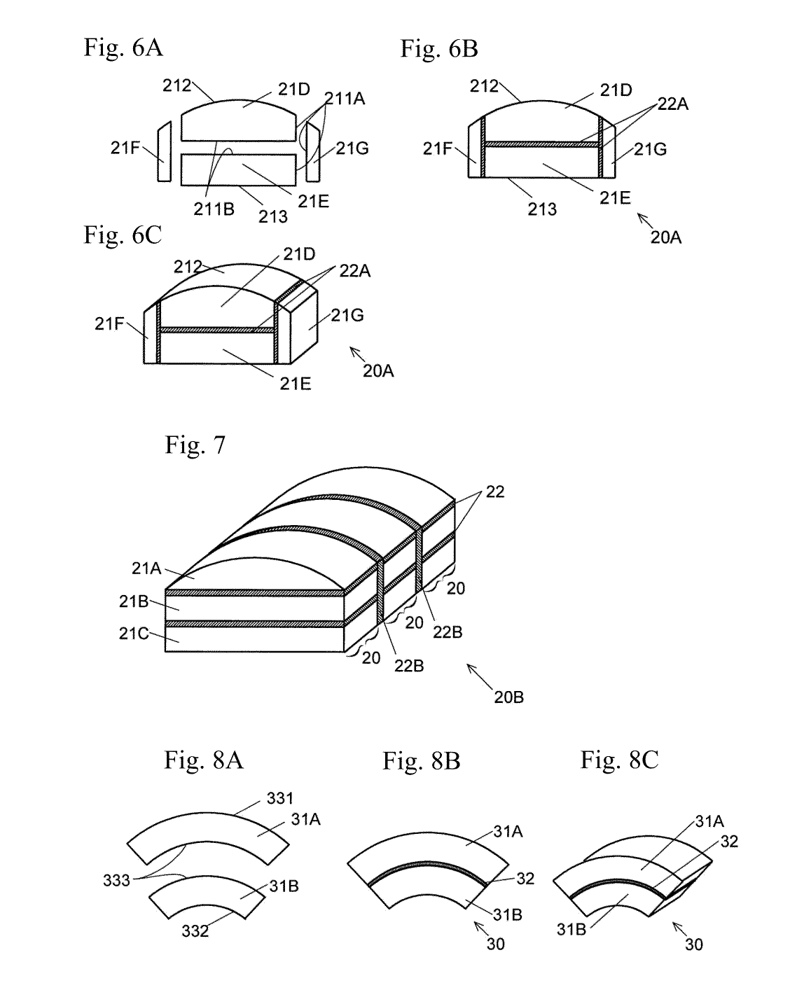

FIGS. 6A to 6C illustrate another Example of the dome-shaped combined type magnet. When compared to the above-described dome-shaped combined type magnet 20, a dome-shaped combined type magnet 20A of this Example, an external shape is the same in each case, but the shapes of the unit magnet and the interface material are different in each case. Unit magnets 21D to 21G of the dome-shaped combined type magnet 20A have a partial shape obtained by dividing the dome-shaped combined type magnet 20A in the vicinity of both ends of the upper surface (arc surface) 212 along a surface 211A perpendicular to the lower surface 213, and by dividing the dome-shaped combined type magnet 20A at the central portion thereof along a surface 211B parallel with the lower surface 213. Accordingly, the surface 211A intersects with the upper surface (arc surface) 212. The surfaces 211A and 211B serve as the bonding surface. An interface material 22A is provided to the bonding surfaces, respectively.

FIG. 7 illustrates another Example of the dome-shaped combined type magnet. A dome-shaped combined type magnet 20B of this Example is obtained by bonding three dome-shaped combined type magnets 20 described above (accordingly, the dome-shaped combined type magnet 20B has a total of nine unit magnets) with an interface material 22B at a cross-section in which the upper surface 212 has an arc shape. In addition, the number of the dome-shaped combined type magnets 20 that are bonded is not limited to three, and may be two or four or more.

FIGS. 8A to 8C illustrate Example of a fan surface body combined type magnet. A fan surface body combined type magnet 30 is a fan surface body having a first arc surface 331, and a second arc surface 332 that is opposite to the first arc surface 331. A unit magnet of the fan surface body combined type magnet 30 includes a first unit magnet 31A and a second unit magnet 31B that are obtained by dividing the fan surface body at a third arc surface 333 positioned between the first arc surface 331 and the second arc surface 332. The first arc surface 331, the second arc surface 332, and the third arc surface 333 are concentric to each other at a cross-section, and have arc shapes having diameters different from each other. The first unit magnet 31A and the second unit magnet 31B are formed from the same material as Examples described above, and may be prepared by the same method as Examples described above. The third arc surface 333 serves as a bonding surface and an interface material 32 is provided to the bonding surface. Accordingly, in this Example, the bonding surface does not intersect with the first arc surface 331 and the second arc surface 332 which are positioned on surfaces of the fan surface body combined type magnet 30 and which are nonplanar surfaces. A material of the interface material 32 is the same as the material of the interface materials in Examples described above. In addition, the first arc surface 331 and the second arc surface 332 may not be concentric to each other at a cross-section, and the third arc surface 333 may not be concentric to the first arc surface 331 and/or the second arc surface 332. In addition, the bonding surface may be a planar surface that does not intersect with the first arc surface 331 and the second arc surface 332.

### (4) Measurement Results of Magnetic Properties of RFeB-Based Combined Type Magnet Prepared in Examples

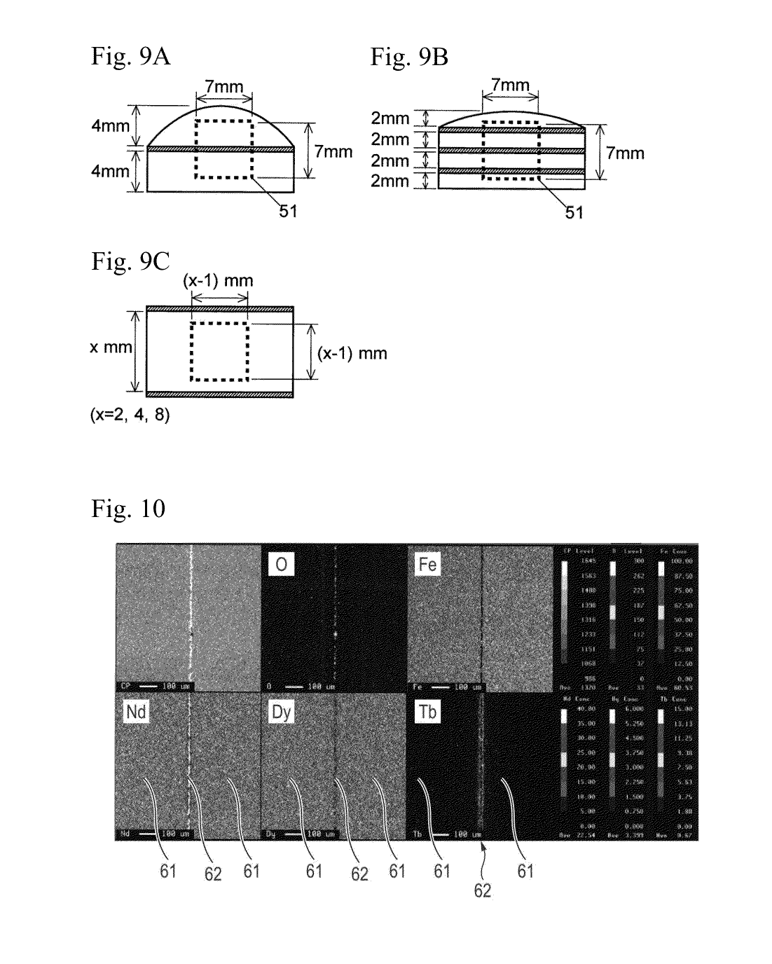

Hereinafter, results, which are obtained by performing measurement of the magnetic properties (the residual magnetic flux density and the coercive force) with respect to the dome-shaped combined type magnets prepared in Examples, are shown. Here, as the dome-shaped combined type magnets, as shown in FIGS. 9A to 9C, a dome-shaped combined type magnet obtained by using one unit magnet having an arc surface and one flat plate-shaped unit magnet (FIG. 9A), and a dome-shaped combined type magnet obtained by using one unit magnet having an arc surface and three plate-shaped unit magnets (FIG. 9B) were used. The thickness of each magnet was set to 4 mm (FIG. 9A) and 2 mm (FIG. 9B). Here, the thickness of the unit magnet having an arc surface was defined as a distance between the vertex of the arc surface and the lower surface. In all Examples, the total thickness of the unit magnets was set to 8 mm. The upper surface and the lower surface of each of the dome-shaped combined type magnets were respectively ground by 0.5 mm to be parallel with surfaces of a flat plate-shaped unit magnet, and then a test specimen, which has dimensions of 7 mm×7 mm with a thickness of 7 mm, was cut from the magnet. Here, in FIG. 9A, the interface material was set to be positioned at the center in the thickness direction of the test specimen, and in FIG. 9B, among three sheets of the interface materials, the central interface material was disposed at the center. For comparison, the R^{H}-containing paste used in Examples was applied to two upper and lower surfaces of a base material of a plate-shaped sintered magnet prepared by the same material as the unit magnets in Examples, and then the grain boundary diffusion treatment was performed in the same manner as Examples, thereby preparing a sample of Comparative Example (FIG. 9C). In all of Examples and Comparative Example, a plurality of samples, in which a surface density ρ of the R^{H}-containing paste was different in each case, were prepared.

Preparation conditions of each the samples, and measurement results on the magnetic properties of the sample that was obtained are shown in Table 1. Here, in Comparative Examples 3 and 4, two sheets of flat plate-shaped unit magnets, which were obtained by respectively grinding the upper and lower surfaces by 0.25 mm to have a thickness of 3.5 mm, were superimposed on each other. In Comparative Example 5, five sheets of flat plate-shaped unit magnets, which were obtained by respectively grinding the upper and lower surfaces by 0.35 mm to have a thickness of 1.4 mm, were superimposed on each other. Therefore, the measurement was performed in the same thickness as the test specimens 51 of Examples 1 to 5.

TABLE 1

| | | | | Density of | | Residual | |
|---|---|---|---|---|---|---|---|
| | Number of | Thickness of | Number of | paste per | Total amount | magnetic flux | Coercive |
| | unit | unit magnet | paste layers | layer ρ | of paste | density Bᵣ | force H_{cj} |
| | magnets | [mm] | n | [mg/cm²] | n × ρ × S [mg] | [kG] | [kOe] |
| Example 1 | 2 | 4 | 1 | 20 | 20S | 13.3 | 33.3 |
| Example 2 | 2 | 4 | 1 | 10 | 10S | 13.4 | 30.7 |
| Example 3 | 2 | 4 | 1 | 8 | 8S | 13.4 | 30.5 |
| Example 4 | 4 | 2 | 3 | 7 | 21S | 13.2 | 33.6 |
| Example 5 | 4 | 2 | 3 | 6 | 18S | 13.3 | 31.9 |
| Example 6 | 4 | 2 | 3 | 5 | 15S | 13.3 | 31.9 |
| Comparative | 1 | 8 | 2 | 40 | 80S | 13.2 | 30.0 |
| Example 1 | | | | | | | |
| Comparative | 1 | 8 | 2 | 20 | 40S | 13.1 | 25.4 |
| Example 2 | | | | | | | |
| Comparative | 1 | 4 | 2 | 20 | 40S | 13.3 | 31.2 |
| Example 3 | | | | | | | |
| Comparative | 1 | 4 | 2 | 10 | 20S | 13.1 | 27.8 |
| Example 4 | | | | | | | |
| Comparative | 1 | 2 | 2 | 10 | 20S | 13.3 | 31.6 |
| Example 5 | | | | | | | |

* S: Paste application area per layer
In all Examples, S = 7 mm × 7 mm = 49 mm² = 0.49 cm²

From Table 1, it can be seen that when compared to Comparative Example 1, in samples of respective Examples, a used amount of the R^{H}-containing paste (in Table 1, abbreviated as “paste”) is as small as 12.5% (5/40) to 50% (20/40) of Comparative Example 1, and a coercive force equal to or more than a coercive force of Comparative Example 1 is obtained. In addition, even though the used amount of the R^{H}-containing paste is less than that of the samples of Comparative Examples 2 and 3, the samples of respective Examples have a coercive force which is higher than that of the sample of Comparative Example 2, and which is equal to or higher than that of the sample of Comparative Example 3. In addition, the used amount of the R^{H}-containing paste of Example 1 is substantially the same as Comparative Examples 4 and 5, and the coercive force is higher than that of Comparative Examples 4 and 5. The used amount of the R^{H}-containing paste in Examples 2 to 5 is relatively less than that of Comparative Examples 4 and 5, and the coercive force is equal to or more than that of Comparative Examples 4 and 5. The reason why these experiment results are obtained is considered as follows. In Comparative Examples, the R^{H}-containing paste is applied to an external surface of the magnet, and thus the R^{H} does not diffuse into the magnet from a portion of the applied R^{H}-containing paste which is spaced away from the external surface (approximately half of the total amount). In addition, when the magnet is thick, diffusion of the R^{H} from the vicinity of the external surface is less likely to occur. In contrast, in Examples, the R^{H} diffuses to the two unit magnets on both sides of a R^{H}-containing paste layer, and thus it is possible to perform the grain boundary diffusion treatment with efficiency within a short time. In addition, in Examples, the R^{H} is not likely to be oxidized in comparison to a case of Comparative Example in which application is performed to the external surface of the magnet, and thus the grain boundary diffusion treatment can be sufficiently performed using a smaller application amount of the R^{H}-containing paste. As described above, in the samples of respective Examples, it is possible to increase the coercive force while suppressing the used amount of the R^{H}-containing paste in comparison to Comparative Examples.

(5) Results of Composition Analysis on Combined Type RFeB-Based Magnet Prepared in Examples

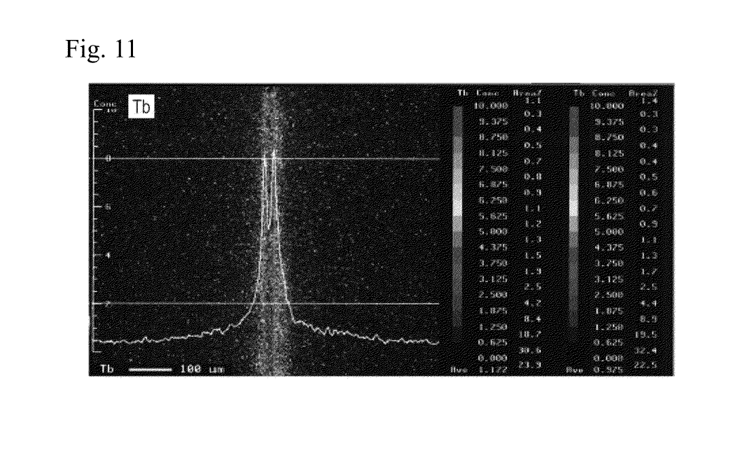

An experiment for detecting O (oxygen), Fe, Nd, Dy, and Tb atoms was performed with respect to the sample of Example 4 by using an electron probe microanalysis (EPMA) method. The results are shown in FIGS. 10 and 11. In images of the drawings, the more atoms are at a bright portion (color near to white) in comparison to a dark portion (color near to black). In all elements, in the vicinity of the center of the images, a strip pattern region having a color different from that of surroundings is found in a vertical direction. The strip pattern region corresponds to an interface material 62, and the other regions correspond to a unit magnet 61.

The following can be said from FIG. 10. First, in an image indicating the amount of Tb, the interface material 62 is shown brightly in comparison to the surroundings, and it is shown that Tb is contained in the interface material 62 in an amount more than that of the surroundings. In addition, within the unit magnet 61, as it is close to the interface material 62, it is shown brightly. This represents that the Tb atoms diffuse to the inside of the unit magnet 61 from the R^{H}-containing paste, and as it is close to the R^{H}-containing paste (interface material 62), the Tb atoms are present in a relatively large amount. FIG. 11 is a graph illustrating a distribution of the amount of Tb in a direction perpendicular to the interface material 62 in the image indicating the amount of Tb of FIG. 10. From this graph, it can be seen that the Tb atoms diffuse to the inside of the unit magnet 61.

Fe atoms and Dy atoms which are not contained in the R^{H}-containing paste are substantially not present in the interface material 62, but Nd atoms that are also not contained in the R^{H}-containing paste are present in the interface material 62. This represents that Nd atoms substituted due to diffusion of the Tb atoms into the unit magnet 61 precipitate to the interface material 62. In addition, O (oxygen) atoms are substantially not present in the unit magnet 61, but a lot of oxygen atoms are present in the interface material 62.

In addition, as shown in FIG. 11, in the vicinity of the center of the interface material 62, the amount of Tb is less than that in the vicinity of the interface with the unit magnet 61. It is considered that in the vicinity of the center, O and Nd increase instead of Tb.

From the result of the EPMA experiment, it is considered that (i) the Tb atoms diffuse to the inside of the unit magnet 61 from the R^{H}-containing paste (interface material 62), and (ii) Nd oxides are formed in the interface material 62. Accordingly, in the combined type RFeB-based magnets of Examples, it is possible to increase the coercive force by the grain boundary diffusion treatment, and it is possible to suppress an effect of an eddy current by the interface material 62 in which electrical resistivity increases due to oxides.

The invention is not limited to Examples described above.

For example, examples of using a sintered magnet prepared by the PLP method have been illustrated, but a sintered magnet prepared by a press method that has been widely used in the related art may be used. In addition, a hot-plastic worked magnet described in Non-Patent Document 1 may be used.

In addition, the R^{H}-containing paste is not limited to the paste obtained by mixing the Tb-containing powder obtained by pulverizing the TbNiAl alloy into a powder and the silicone grease. For example, a powder that contains Dy or Ho may be used, or an elementary substance of the R^{H} or a compound (a fluoride and the like) thereof other than an alloy may be used. In addition, as the organic solvent, in addition to the silicone grease that is used in Examples, liquid hydrocarbon such as flowable paraffin, hexane, and cyclohexane, and the like may be used.

While the mode for carrying out the present invention has been described in detail above, the present invention is not limited to these embodiments, and various changes and modifications can be made therein without departing from the purport of the present invention.

This application is based on Japanese patent application No. 2013-208937 filed Oct. 4, 2013, the entire contents thereof being hereby incorporated by reference.

### DESCRIPTION OF REFERENCE NUMERALS AND SIGNS

10, 10A, 10B: Ring-shaped combined type RFeB-based magnet

11, 11A, 21D to 21G, 61: Unit magnet

111, 211, 211A, 211b: Bonding surface

12, 12A, 12B, 22, 22A, 32, 62: Interface material

20, 20A: Dome-shaped combined type magnet

212: Arc surface (upper surface)

213: Lower surface

21A, 31A: First unit magnet

21B, 31B: Second unit magnet

21C: Third unit magnet

22, 22A: Interface material

30: Fan surface body combined type magnet

331: First arc surface

332: Second arc surface

333: Third arc surface

41: Alloy powder

42: Mold

421: Cavity of mold

43: R^{H}-containing paste

431: R^{H}-containing metal powder

432: Silicone grease

51: Test specimen

What is claimed is:

1. A combined type RFeB-based magnet, comprising:
two or more unit magnets; and
an interface material that bonds bonding surfaces of the unit magnets adjacent to each other,
wherein each of the unit magnets is an RFeB-based magnet containing a light rare earth element R^{L} that is at least one element selected from the group consisting of Nd and Pr, Fe, and B,
wherein the interface material contains at least one compound selected from the group consisting of a carbide, a hydroxide, and an oxide of the light rare earth element R^{L}, and
wherein the combined type RFeB-based magnet contains at least one element selected from the group consisting of Dy, Ho and Tb, and has a nonplanar surface.

2. The combined type RFeB-based magnet according to claim 1,
wherein the bonding surface is a planar surface.

3. The combined type RFeB-based magnet according to claim 1,
wherein the carbide, the hydroxide, and the oxide of the light rare earth element R^{L} are not attached to the nonplanar surface.

4. The combined type RFeB-based magnet according to claim 2,
wherein the carbide, the hydroxide, and the oxide of the light rare earth element R^{L} are not attached to the nonplanar surface.

5. The combined type RFeB-based magnet according to claim 1,
wherein the bonding surface does not intersect with the nonplanar surface.

6. The combined type RFeB-based magnet according to claim 1,
wherein the combined type RFeB-based magnet is a tubular magnet having a ring-shaped cross-section, and
wherein the unit magnet has the bonding surface that extends in a central axial direction of the tubular magnet.

7. The combined type RFeB-based magnet according to claim 2,
wherein the combined type RFeB-based magnet is a tubular magnet having a ring-shaped cross-section, and
wherein the unit magnet has the bonding surface that extends in a central axial direction of the tubular magnet.

8. The combined type RFeB-based magnet according to claim 1,
wherein combined type RFeB-based magnet has a dome shape in which only one surface of a rectangular parallelepiped is an arc surface, and
wherein the bonding surface of the unit magnet does not intersect with the arc surface.

9. The combined type RFeB-based magnet according to claim 1,
wherein the combined type RFeB-based magnet has a dome shape in which only one surface of the rectangular parallelepiped is an arc surface, and
wherein the bonding surface of the unit magnet intersects with the arc surface.

10. The combined type RFeB-based magnet according to claim 2,
wherein the combined type RFeB-based magnet has a dome shape in which only one surface of the rectangular parallelepiped is an arc surface, and
wherein the bonding surface of the unit magnet intersects with the arc surface.

11. The combined type RFeB-based magnet according to claim 1,
wherein the combined type RFeB-based magnet has a fan surface body shape having a first arc surface and a second arc surface that is an opposite to the first arc surface, and
the bonding surface of the unit magnet is an arc surface that is positioned between the first are surface and the second arc surface.

12. The combined type RFeB-based magnet according to claim 1,
wherein a plurality of the unit magnets having a plate shape having a thickness of 8 mm or less are stacked.

13. A method for producing a combined type RFeB-based magnet in which a plurality of unit magnets that are sintered magnets or hot-plastic worked magnets are bonded to each other at a bonding surface and which has a nonplanar surface, sintered magnets or the hot-plastic worked magnets being an RFeB-based magnet that contains at least one kind of light rare earth element R^{L} selected from Nd and Pr, Fe, and B, the method comprising:
performing heating in a state in which bonding surfaces of two unit magnets adjacent to each other in the combined type RFeB-based magnet are brought into contact with each other through paste obtained by mixing a metal powder containing at least one kind of heavy rare earth element R^{H} selected from Dy, Ho, and Tb, and an organic material to perform a grain boundary diffusion treatment.

14. The method for producing a combined type RFeB-based magnet according to claim 13,
wherein the bonding surface is a planar surface.

15. The method for producing a combined type RFeB-based magnet according to claim 13,
wherein in the grain boundary diffusion treatment, the paste is not attached to the nonplanar surface.

16. The method for producing a combined type RFeB-based magnet according to claim 14,
wherein in the grain boundary diffusion treatment, the paste is not attached to the nonplanar surface.

17. The method for producing a combined type RFeB-based magnet according to claim 13,
wherein the bonding surface does not intersect with the nonplanar surface.
